(19) United States
(12) Patent Application Publication
(10) Pub. No.: US 2003/0018910 A1
(43) Pub. Date: Jan. 23, 2003

(54) System and methods for providing multi-level security in a network at the application level

(75) Inventors: Brian W. Wert, Raleigh, NC (US); Mark Acri, Henderson, NC (US)

Correspondence Address: PRIEST & GOLDSTEIN PLLC, 5015 SOUTHPARK DRIVE, SUITE 230, DURHAM, NC, 27713-7736, US

(73) Assignee: GE Capital Mortgage Corporation, Raleigh, NC

(21) Appl. No.: 09/908,512

(22) Filed: Jul. 18, 2001

(51) Int. Cl. G06F 12/14

(52) U.S. Cl. 713/200

(57) ABSTRACT

Systems and methods are described for providing multi-level security for a software application. In one system, an application programming interface provides access to secured software applications. A database stores authorizations granting each user access to selected applications, selected application screens, and selected fields within application screens. The application programming interface is configured such that a security software application prevents a user from gaining access to an application, screen, or field unless authorization has previously been given. A further system provides for the assignment of privileges to users of the application. These privileges define the specific functions that a user is allowed to perform with respect to an authorized application, screen, or field.

### BACKGROUND OF THE INVENTION

1. Field of the Invention

The present invention relates generally to improvements to systems and methods for providing security in a network environment, and more particularly to advantageous aspects of systems and methods for providing multi-level security to network applications.

2. Description of the Prior Art

In today's business organizations, it is not uncommon for a relatively large number of employees to have access to centrally stored business data. With the development of the Internet and other business technologies, the number of employees having access to centrally stored data is ever increasing. Because of the increased access to data, there is also an increased need to provide for data security. First, certain information may be proprietary or sensitive in nature and should therefore only be accessed by authorized individuals. In addition, other data must be protected from being deleted, modified, or otherwise tampered with. The security issue is further complicated by the fact that centrally stored data may be processed by a number of separate software applications.

Prior art security systems typically provide security by granting or denying access to a user at a relatively high level. For example, a user may be granted or denied access when the user attempts to use a particular software application in a network environment. However, in many situations, this “all or nothing” approach to securing a software application prevents a business organization from fine-tuning its security system. For example, it may be desirable to grant certain users of the system access to portions of an application, while denying access to the remainder of the application. Current security systems typically lack this flexibility.

### SUMMARY OF THE INVENTION

The above-described issues and others are addressed by the present invention, one aspect of which provides systems and methods for providing multi-level security for a software application. According to this aspect of the invention, an application programming interface provides access to the secured software applications. A database stores authorizations granting each user access to selected applications, selected application screens, and selected fields within application screens. The application programming interface is configured such that a security software application prevents a user from gaining access to an application, screen, or field unless authorization has previously been given. A further aspect of the invention provides for the assignment of privileges to users of the application. These privileges define the specific functions that a user is allowed to perform with respect to an authorized application, screen, or field.

Additional features and advantages of the present invention will become apparent by reference to the following detailed description and accompanying drawings.

### BRIEF DESCRIPTION OF THE DRAWINGS

FIG. 1 shows a diagram of a system for providing multi-level security to a software application according to a first aspect of the present invention.

FIG. 2 shows a diagram of a system for providing multi-level security to a software application according to a further aspect of the present invention.

FIG. 3 shows a flowchart of a method for providing multi-level security to a software application according to a further aspect of the present invention.

FIGS. 4 through 35 show screenshots of web pages for a website embodying a security system according to the present invention. Each web page is described briefly below.

FIG. 4 shows a logon screen.

FIG. 5 shows a main menu of the website.

FIG. 6A shows a “Get a Note” screen.

FIG. 6B shows an “Update a Note” screen.

FIG. 7 shows an “User Info” screen.

FIGS. 8A and 8B show the “User Info” screen shown in FIG. 7, with retrieved user information displayed at the bottom of the screen.

FIG. 9 shows a main menu of a security software application run from the website.

FIG. 10 shows a “User Main Menu” screen.

FIG. 11 shows the “User Main Menu” screen shown in FIG. 10 with the drop-down menu opened.

FIG. 12 shows an “Add a New User” screen.

FIG. 13 shows an “Attach Users to Application Roles” screen.

FIG. 14 shows an “Update a User” screen.

FIG. 15 shows a “Role Main Menu” screen.

FIG. 16 shows an “Add a New Role” screen.

FIG. 17 shows an “Update a Security Role” screen.

FIG. 18 shows an “Attach Application Roles to Privileges” screen.

FIG. 19 shows a “Privilege Main Menu” screen.

FIG. 20 shows an “Add a New Privilege” screen.

FIG. 21 shows an “Update a Privilege” screen.

FIG. 22 shows an “Application Main Menu” screen.

FIGS. 23A and 23B show an “Add a New Application” screen.

FIG. 24 shows an “Update an Application” screen.

FIG. 25 shows an “Attach Applications to Roles” screen.

FIG. 26 shows an “Add a New Screen” screen.

FIG. 27 shows an “Update a Screen” screen.

FIG. 28 shows a modified “Application Main Menu” screen, which is displayed after the action “Assign Screen Privileges” has been selected.

FIG. 29 shows an “Assign Screen Privileges” screen.

FIG. 30 shows an “Add a New Field” screen.

FIG. 31 shows an “Update a Field” screen.

FIG. 32 show a modified “Application Main Menu” screen, which is displayed after the action “Assign Field Privileges” has been selected.

FIG. 33 shows an “Assign Field Privileges” screen.

FIG. 34 shows a “Type Code Main Menu” screen.

FIG. 35 shows a “Capitalization Maintenance” screen.

FIG. 36 shows a collection of data objects according to a further aspect of the invention.

FIG. 37 shows a diagram of a system server setup according to a further aspect of the invention.

### DETAILED DESCRIPTION

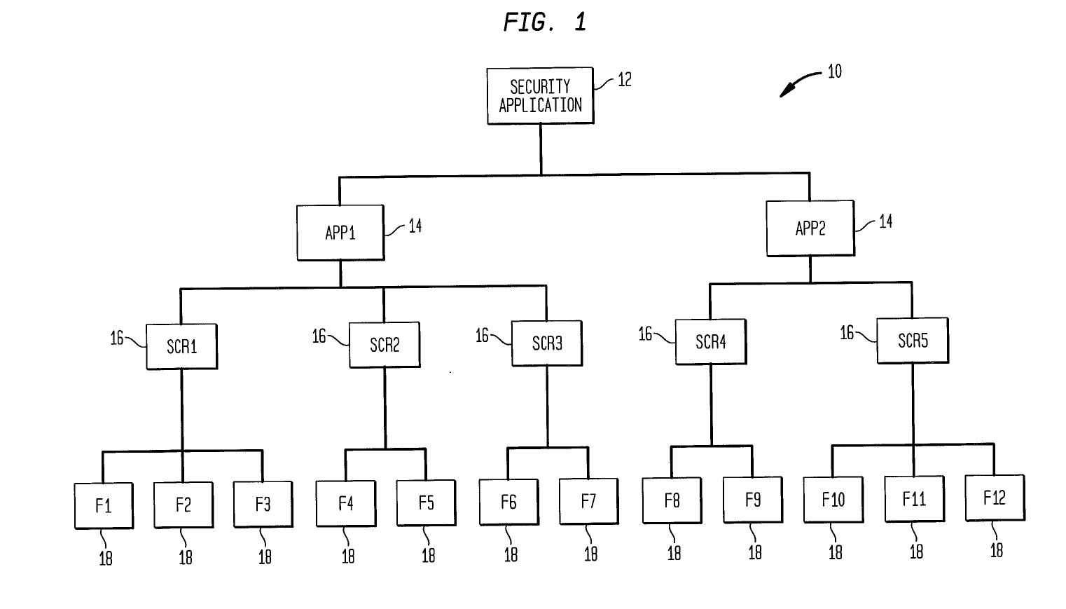

An aspect of the present invention provides a system for securing a software application, in which access to the software application is granted at multiple levels. FIG. 1 is a diagram illustrating a system 10 according to this aspect of the invention. A security software application 12 sits atop a number of applications 14 to be secured. Each secured application 14 includes a number of screens 16, and each screen 16 includes a number of fields 18 for data input and output. Users are granted authorizations to use the secured applications 14 at the application level, at the screen level, and at the field level.

For example, a user may be granted authorization to use a first application APP1, but not a second application APP2. However, the user's use of APP1 may be further limited at the screen level. Thus, the user may be granted authorization to use first and second screens SCR1 and SCR2, but may be denied access to a third screen SCR3. In addition, the user's use of screens SCR1 and SCR2 may be limited at the field level. A user may be granted authorization to use fields F1 and F4 but be denied access to the remainder of the fields F2, F3 and F5.

According to a further aspect of the invention, even if a user is granted access to a screen or a field, that access may be limited by the types of functions that the user is authorized to perform on that screen or field. For example, in a system described below, the user may be granted one or more privileges from the following set: delete, inquire, insert, update.

It will be seen that a security system according to the present invention provides significant flexibility in managing that security system by allowing a security administrator to determine on a case-by-case basis which applications, screens, and fields a user or class of users may be allowed to access, and to further determine which functions that user or class of users is allowed to perform on the accessed screen or field.

According to a further aspect of the invention, the security system is implemented in a network environment. The secured software applications are run as web applications on a server computer. A user accesses the web applications from a personal computer or workstation that is connected to the server using the Internet or other network connection. The personal computer or workstation interfaces with the server computer using a web browser, such as Microsoft Internet Explorer or Netscape Navigator. As above, users are granted access to each of the secured applications on the application level, on the screen level, or on the field level.

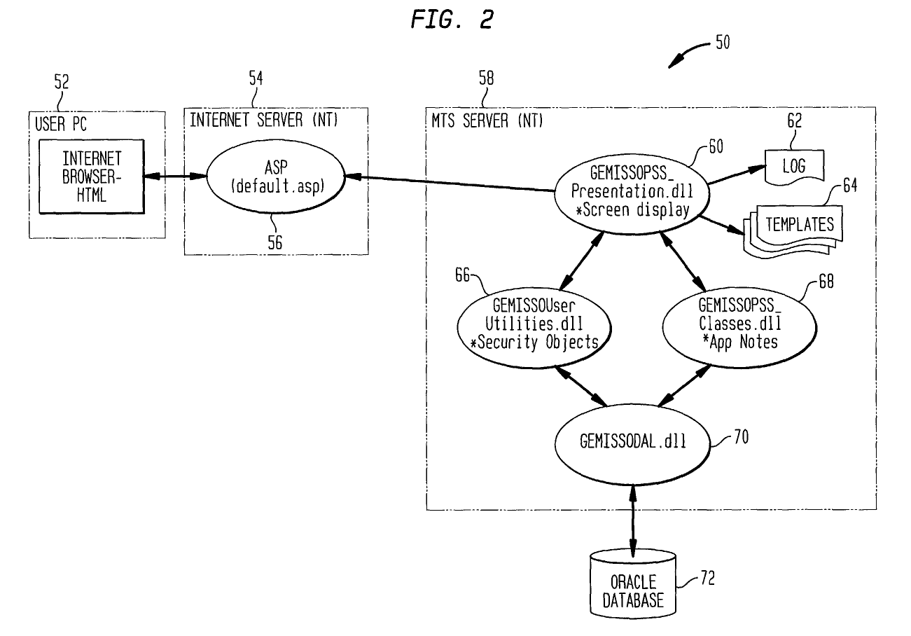

FIG. 2 shows a security system 50 according to a further aspect of the present invention, in which the system 50 is implemented in a web environment. As shown in FIG. 2, the security system 50 includes a user personal computer (PC) 52, or workstation, running a web browser, such as Microsoft Internet Explorer or Netscape Navigator. The user PC 52 is connected, via the Internet or other network, to a server computer 54, running on a suitable operating system platform, such as Windows NT. The web server computer 54 communicates with the user PC using active server pages (ASPs).

The Internet server 54 is connected to a Microsoft transaction server (MTS) 58, also running on a Windows NT operating system platform. In the present configuration, a dynamic link library (DLL) called GEMISSOPSS_Presentation.dll 60 is used to generate the contents of the ASPs that are relayed to the system user by the Internet server 54. As shown in FIG. 1, GEMISSOPSS_Presentation.dll 60 is connected to an electronic log 62, which is used for recording significant events in the management of the security system, such as errors. GEMISSOPSS_Presentation.dll 60 is also connected to electronically stored templates 64, which are used in generating the ASPs 66.

GEMISSOPSS_Presentation.dll 60, in turn, communicates with a pair of DLLs: GEMISSOUserUtilities.dll 66 and GEMISSOPSS_Classes.dll 68. GEMISSOUserUtilities.dll 66 functions as an application programming interface (API), which provides an interface between GEMISSOPSS₁₃ Presentation.dll 60 and web applications run on the MTS Server 58. The security application, called “ApplSec,” sits on top of the API, providing access to the secured applications. Specifically, the API is configured such that the ApplSec security application prevents a network user from gaining access to a network software application, screens within the network software application, and fields within the network software application screens, unless authorization has previously been given. GEMISSOPSS_Classes.dll 68 is used to generate application notes that are sent to GEMISSOPSS_Presentation.dll 60 for inclusion in ASPs to be sent to the user at the user PC. GEMISSODAL.dll 70 is a DLL that functions as a data access layer, providing an interface to an Oracle database 72 connected into the network. The Oracle database 72 contains security data, as well as data processed by applications protected by the security system.

It should be noted that a third-party application can be brought under the security blanket by adding appropriate coding to the application. An example of the coding to the be added is included in the source code listing in the Appendix.

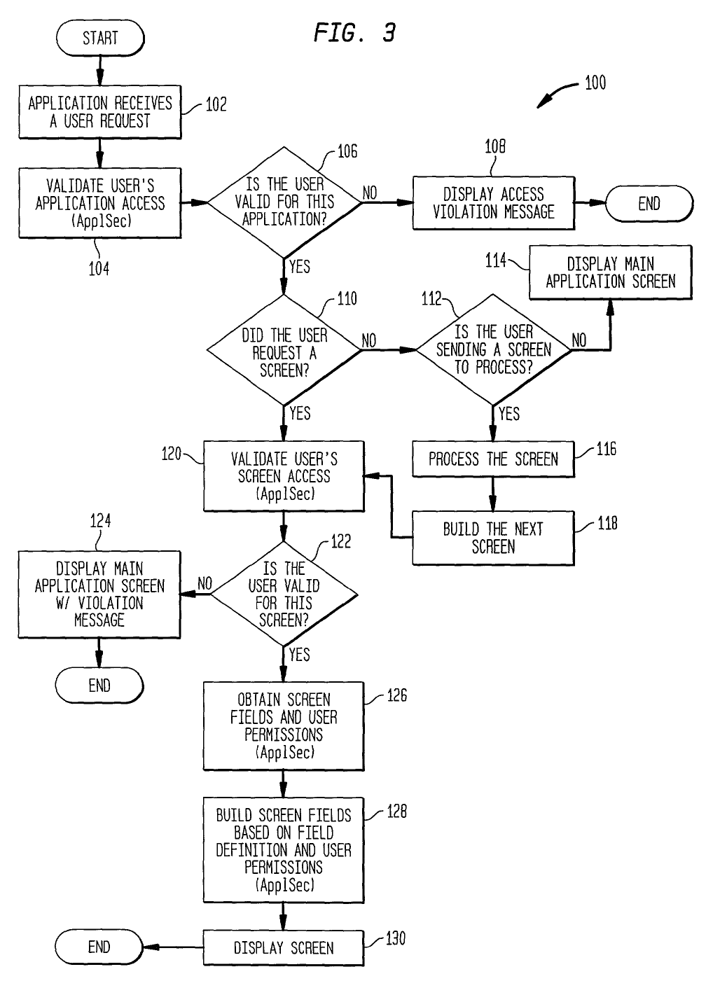

FIG. 3 shows a method 100 according to the present invention for securing web applications in a system such as system 50 illustrated in FIG. 2. It should be noted that, in the present security system, the protected web applications have been designed such that the screen fields are dynamically built into a screen each time the screen is requested. Thus, field level security is implemented by building screen fields based upon field definitions and user authorizations. In providing security at the field level, code is added to these web applications that allow only authorized fields to be built into the requested screen. It will be seen that this particular implementation of the invention creates an “invisible” security function at the field level. A user will not be able to see from the screen displays which fields the user has been denied access to. A field may be a “box” for input or output of data, or it may be an image, or text, or a combination thereof.

However, if a particular web application to be protected by the present security system does not dynamically built fields into a requested screen, it would be within the spirit of the present invention to provide field level security by validating a user's authorization before a user is allowed to make an input in a secured field. In that implementation, the field level security function would no longer be invisible.

Returning to FIG. 3, in step 102, the application receives a user request. In step 104, the security application validates the user's right to access the application. Specifically, in step 106, the system uses the user's identifier to determine whether the user has been granted authorization at the application level to access the requested application. If not, then in step 108, the application causes an “access violation” message to be displayed at the user's terminal, and the process terminates. The API then directs the user to another predetermined location. According to one aspect of the invention, the user's right to access an application is validated each time the user requests the application.

If it is determined in step 106 that the user is valid for the requested application, then in step 110 it is determined whether the user has requested a screen within the requested application. If it is determined that the user is not requesting a screen, then in step 112, it is determined whether the user is sending a screen to process. If not, then in step 114, the main application screen is displayed.

If in step 112 it is determined that the user is sending a screen to process, then in step 116 the screen is processed, and in step 116 the next screen is built. The application then proceeds to step 120, in which the user's screen access is validated by the security application. If, back in step 110 it had been determined that the user had requested a screen, then steps 112 through 118 would be skipped, and the application would proceed directly to step 120.

In step 122 it is determined whether the user is authorized to access the requested screen by using the user's identifier to determine whether access has been granted at the screen level to the requested screen. If not, then in step 124, the application displays the main application screen with a violation message and the security process comes to an end, and the API directs the user to another predetermined location.

If in step 122 it is determined that the user is in fact valid for the screen, then in step 126, the application obtains the screen fields and user authorizations. In step 128, the application builds screen fields based on field definitions and user authorizations. Finally, in step 130 the screen is displayed and the security process comes to an end.

According to an aspect of the invention, the above method 100 is implemented by assigning unique identifiers to each secured application, screen, and field, to each user, and to each privilege. Authorization to access a particular application, screen, or field to a given user is granted by assigning or attaching the respective application identifier, screen identifier, or field identifier to the user identifier. In addition, privileges are granted to a user for each screen or field by attaching the respective privilege identifier to the user's authorization for the screen or the field.

As described below, the process of granting authorizations is facilitated by using defined “roles,” which are classifications of users by functions within the business organization and by level of security clearance. Each role is assigned a unique identifier. Roles are assigned to applications by attaching the role identifiers to the application identifiers. Application roles are assigned to users by attaching application and role identifiers to user identifiers. Authorizations are granted by attaching application, screen or field identifiers to application and role identifiers to user identifiers. The use of roles allows security assignments to be updated or modified at the role level, rather than for each user of the system.

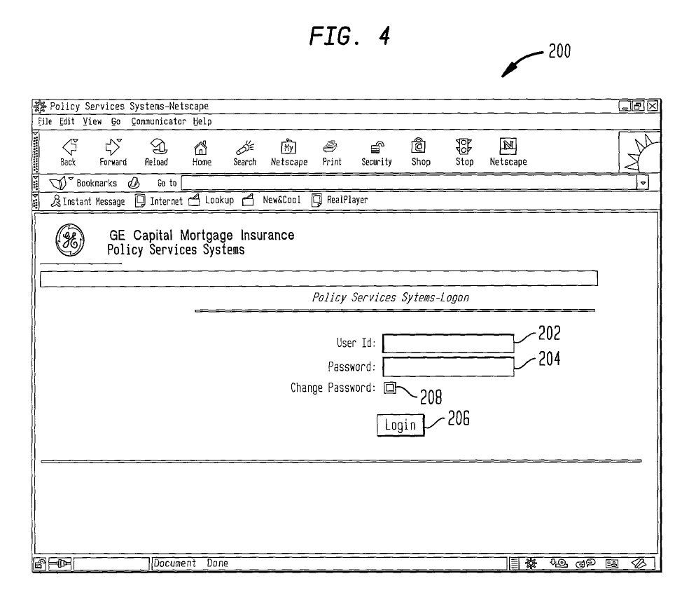

FIGS. 4 through 35 are screenshots of a series of web pages that are used to implement a security system according to the present invention. The present invention includes both a “front end” and a “back end.” The front end of the security system grants network users access to applications, screens, and fields, and includes those components of the system that are visible to general users of the system, such as the logon screen, screens for viewing application notes, and screens for viewing user information. The front end of the security system includes a set of programming modules, implemented as component object model (COM) objects, that query the security database to determine the user's level of clearance. The back end of the security system includes those components of the system that are used by a security administrator or other authorized person to perform the administration functions of the security system. The administration functions include, for example, assigning and updating authorizations to users of the system, adding and updating applications, screens, and fields protected by the security system, and the like. The back end of the security system includes software modules that allow an administrator to perform the initial setup of the security database, and to perform ongoing administrative functions.

According one aspect of the invention, both the front end and the back end of the security system are accessible over the web. It should be noted, also, that the security system preferably provides security for itself. In other words, a security administrator or other authorized person is granted access to the security system at the application, screen, and field levels using the validation functions performed by the security system.

FIG. 4 shows a screenshot of a logon screen 200 according to one aspect of the invention. This is the screen that a user first sees when accessing secured web applications protected by the security system. Users are assigned an identifier (the “User ID”) and an initial password by the security administrator or other authorized person. In logging into the system, the user enters the User ID and password into the respective fields 202 and 204 on the logon screen 200, followed by clicking on the “Login” button 206. The user may change his or her password by clicking on the “Change Password” box 208.

According to a further aspect of the invention, the user's authorization is stored in a cookie that is written to the domain level, so that the cookie is available for use by all applications in the same domain, without having to re-enter the password, until the user logs off or is otherwise disconnected from the network. According to this aspect of the invention, the user's authentication expires at a predetermined time after the initial logon such as, for example, the following midnight. The expiration feature helps to prevent or curtail unauthorized use of the system where, for example, a user has left his or her terminal for the day but has neglected to log off. The logon feature is terminal-specific. Thus, users must log on each time they change their terminal.

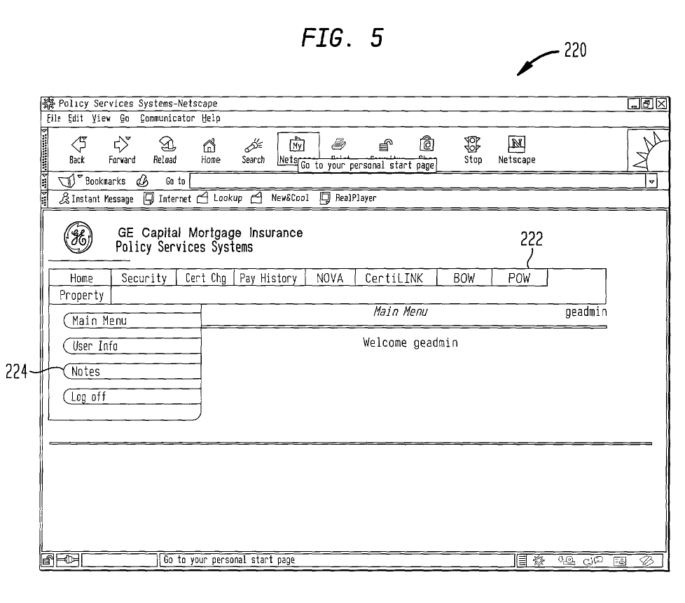

If the User ID and password have been properly recognized by the system, a main menu screen 220, shown in FIG. 5, is displayed to the user. A horizontal menu bar 222 lists web-based applications that are accessible from the Main men screen 220. One of the listed applications is “Security,” which refers to ApplSec, the application used to administer the security system. This application is only accessible by a security administrator or other authorized personnel. The remaining web applications in FIG. 5 are software applications that are used in a mortgage insurance business.

At the left side of the main menu screen 220 is a second menu 224 containing four options: “Main Menu,” which returns the user to the main menu screen, “User Info,” which allows the user to view user information, “Notes,” which displays application notes to the user, and “Logoff,” which logs the user off the system.

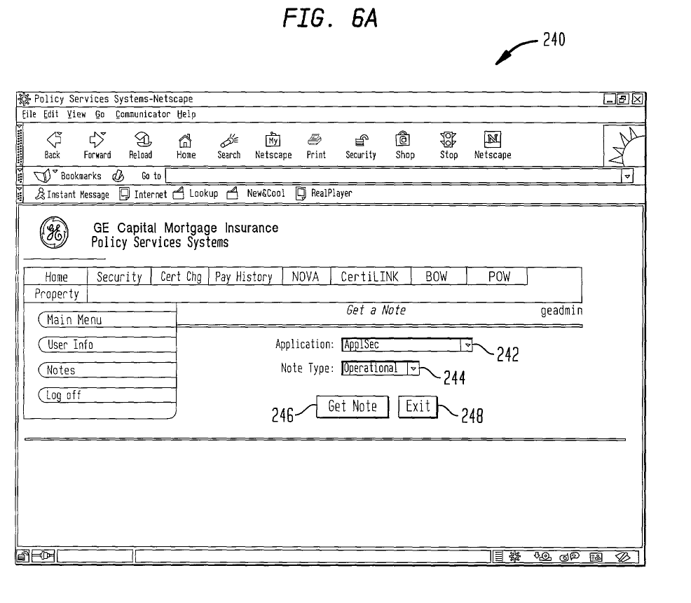

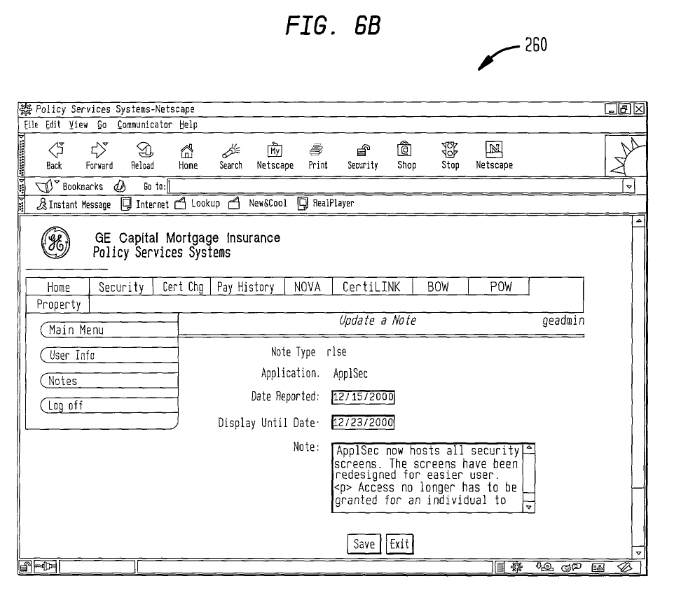

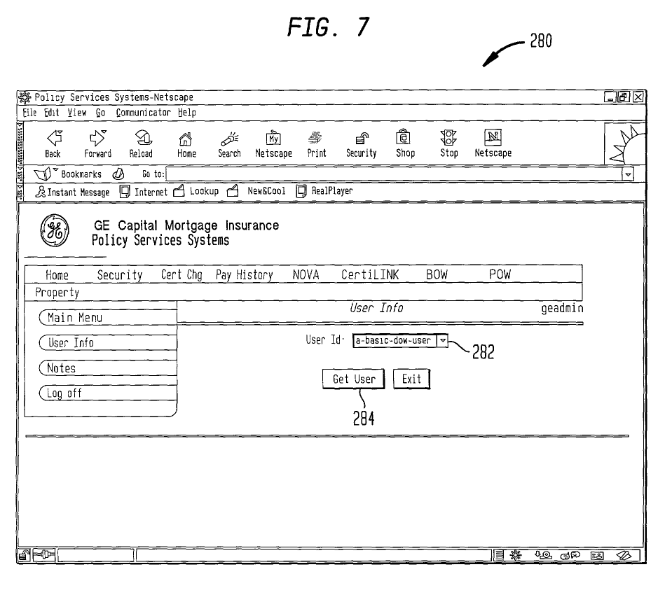

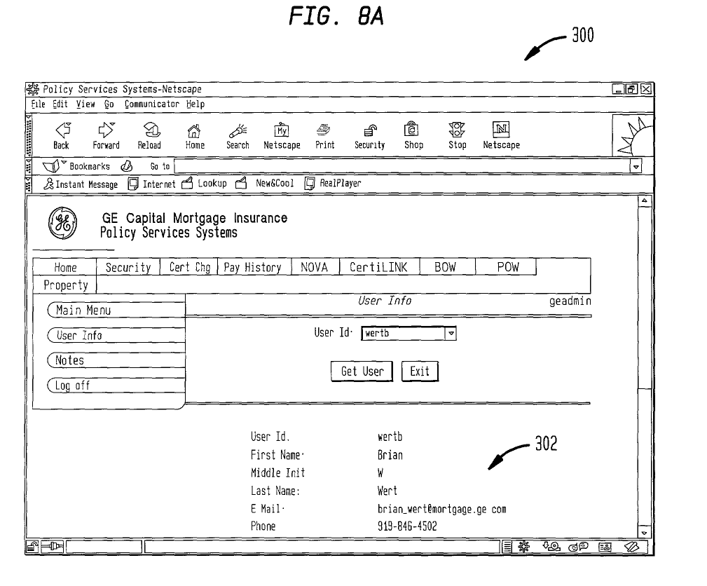

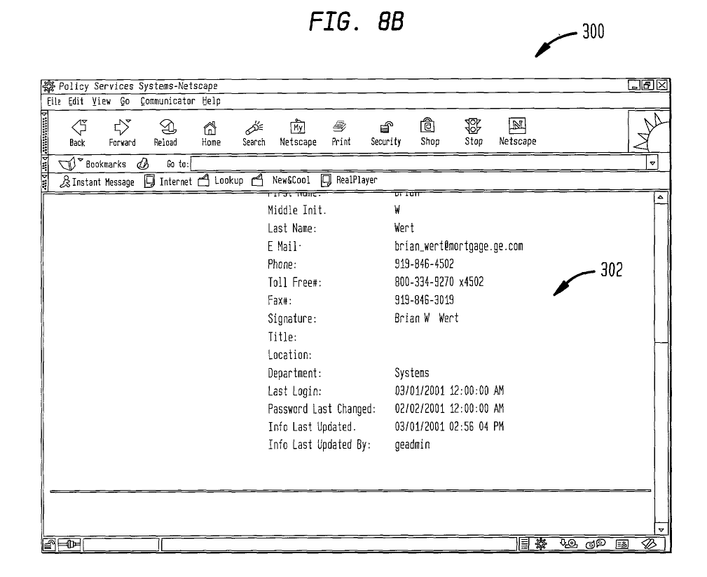

If the user clicks on the “Notes” button, a “Get a Note” screen 240, shown in FIG. 6A, is displayed to the user. The user selects the application for which notes are required using a drop-down menu entry labeled “Application” 242. The user further selects the type of note required using the drop-down menu entry labeled “Note Type” 244. After the application and note type have been identified, the user then clicks on “Get Note” button 246. Otherwise, the user can click on “Exit” button 248 to return to the previous screen. FIG. 6B shows a screenshot of an “Update a Note” screen 260, which is used by an authorized user to update an application note.

FIG. 7 shows a “User Info” screen 280, which is displayed when the user selects “User Info” from the vertical menu at the left of the screen. A drop-down menu labeled “User Id” 282 displays the User IDs for all of the users of the system. Once a user has been identified, the user clicks on “Get User” button 284. As shown in FIGS. 8A and 8B, this selection causes a detailed “User Info” screen 300 to be displayed, which shows the requested user information 302. By scrolling down from screen 300 as seen in FIG. 8A, screen 800 of FIG. 8B with additional user information is reached.

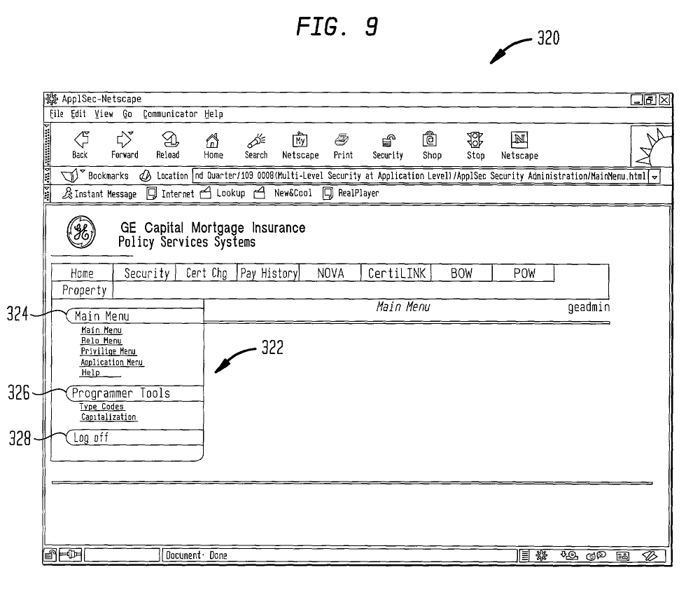

Exemplary security administration screens are now described. When the security administrator or other authorized user clicks on the “Security” button, it brings up a security system main menu screen 320, as shown in FIG. 9. At the left side of the screen 320 is a menu 322 that includes a “Main Menu” portion 324, a “Programmer Tools” portion 326, and a “Logoff” button 328. The “Main Menu” 324 includes the following selections: “User Menu,” “Role Menu,” “Privilege Menu,” and “Application Menu.” The “Main Menu” also includes a selection labeled “Help.” Each of the “Main Menu” selections are discussed below, in turn.

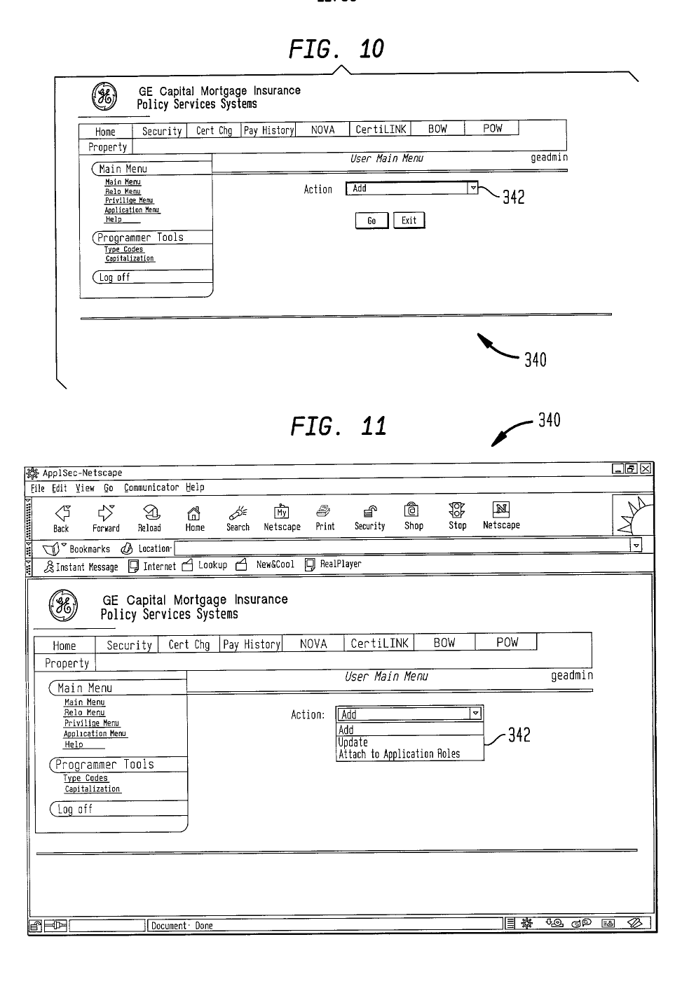

Selecting “User Menu” brings up a “User Main Menu” screen 340 shown in FIG. 10. The “User Main Menu” screen 340 includes a drop-down menu 342 labeled “Action” from which the security administrator selects the action to be performed. FIG. 11 shows the full drop-down menu 342. As shown in FIG. 11, there are three actions listed on the menu: “Add,” which is used to add a new user to the system, “Update,” which is used to update user information, and “Attach to Application Roles,” which is used to attach an identified user to roles in each of the secured applications.

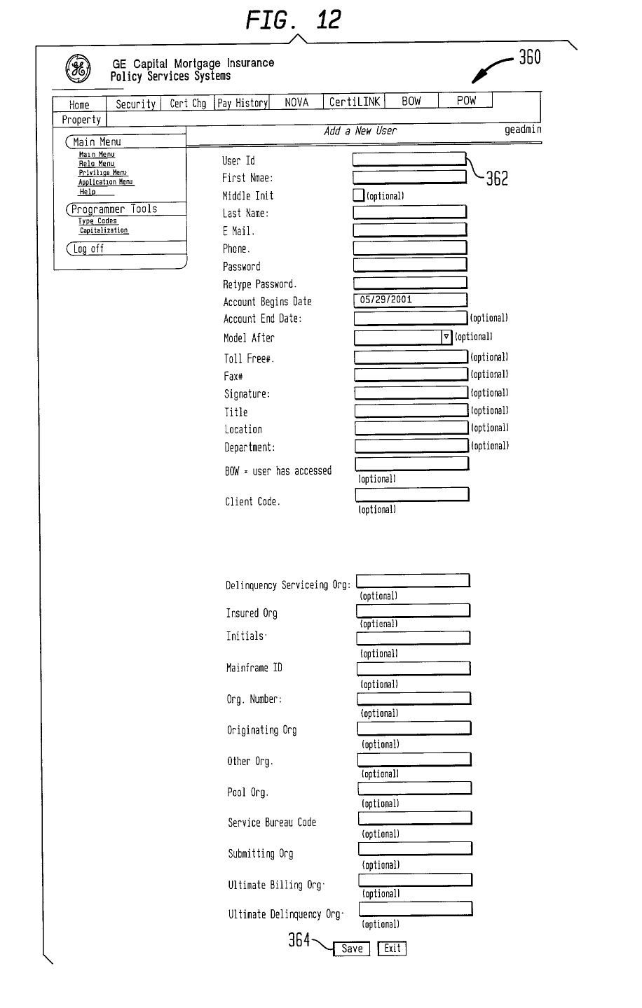

FIG. 12 shows a screenshot of an “Add a New User Screen” 360, which is the screen that is displayed when the user clicks on the “Add” button. As shown in FIG. 12, the “Add a New User Screen” 360 includes a number of data entry boxes 362 for identifying a user to the system and building a user profile. Once the data boxes have been filled in, the security administrator or other authorized user clicks on “Save” button 364 to complete the add operation.

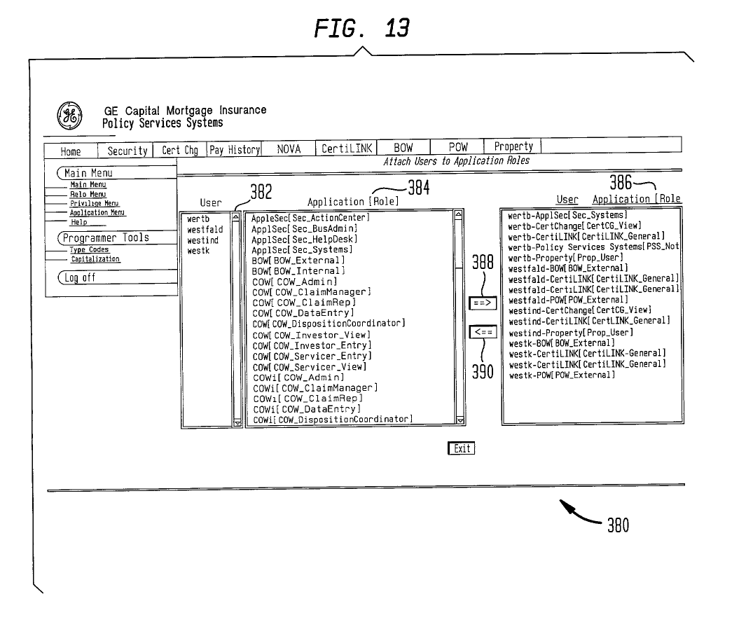

FIG. 13 shows a screenshot of an “Attach Users to Application Roles” screen 362, which is used to assign “application roles” to identified users. Application roles are categories of system users, defined according to the functions that they perform with a certain application and the authorizations and privileges to be granted to them. The creation of application roles is discussed further below. The use of application roles facilitates the granting of authorizations and privileges to users, because it allows security assignments to be designed and modified for groups of users rather than on a case-by-case basis. According to one aspect of the present invention, a user may be assigned a role in more than one application and may be assigned different roles in different applications.

When a user logs into the system and makes a request to access a given application, screen, or field, the security system performs a lookup function in the security database to determine what application roles have been assigned to that user. Based upon the user's application roles, the system then determines which applications, screens, and fields the user has access to, and what functions the user is allowed to perform on the accessed applications, screens or fields.

As shown in FIG. 13, the “Attach Users to Application Roles” screen 380 includes three list boxes: a user list 382, a list of application roles 384, and a list of application role assignments 386. An application role is assigned to a user by highlighting a user in the user list 382 and an application role in the application role list 382 and then clicking on right arrow button 388. If an entry is to be removed from the assignment list 386, the user highlights the entry and then clicks on the “left arrow” button 390. As a timesaving feature, more than one item in a list may be highlighted at once. This highlighting allows multiple assignments, or removals of assignments, to be made at the same time.

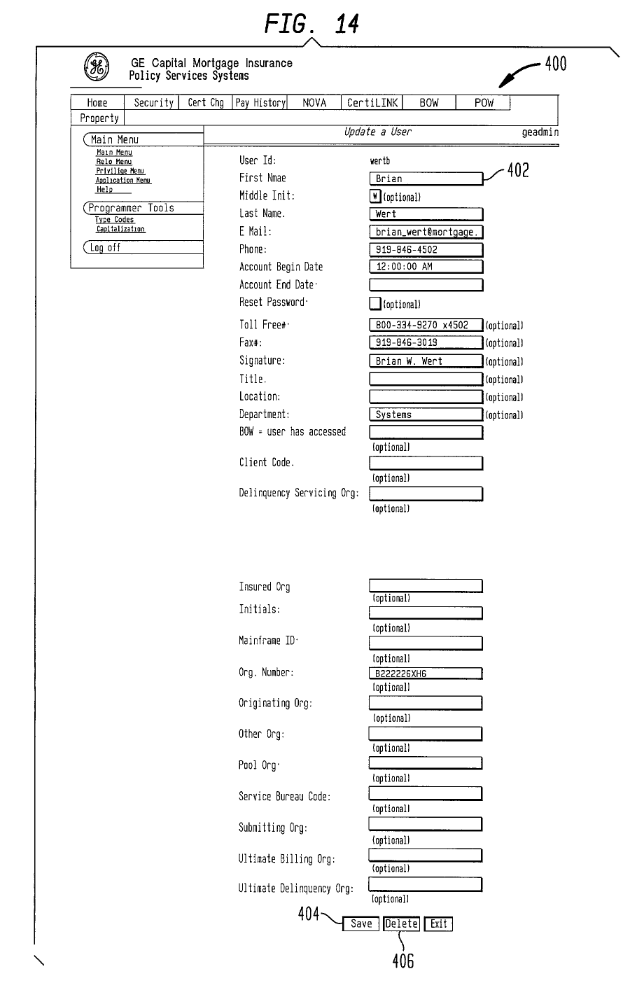

FIG. 14 shows an “Update a User” screen 400, which is accessed by selecting the “Update” option from the drop-down menu 342 on the “User Main Menu” shown in FIG. 11. The “Update a User” screen 400 retrieves existing user information and displays it in data entry boxes 402. The user can then modify or update this information and then press “Save” button 404 to save the information. The user may also delete the user record entirely by clicking on “Delete” button 406.

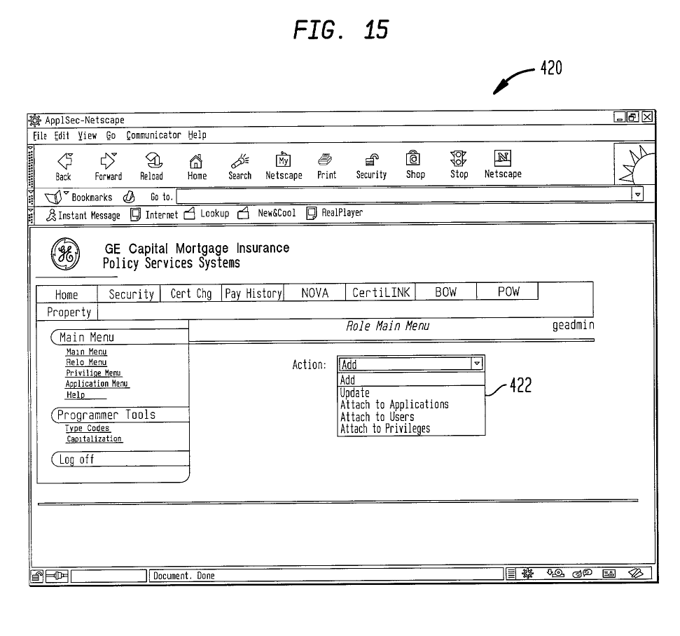

FIG. 15 shows a “Role Main Menu” screen 420. This screen 420 includes a dropdown menu 422, from which the user selects a desired action. These actions include: “Add,” “Update,” “Attach to Application,” “Attach to Users,” “Attach to Privileges.” “Add” and “Update” are selected in order to create new roles or to modify roles that have been previously created. Their respective selection takes the security administrator to the “Add a New Role” or “Update a Security Role” screens discussed immediately below. “Attach to Application” is selected in order to attach a defined role to an application, and takes the security administrator to a screen called “Attach Applications to Roles,” discussed below in conjunction with the “Application Main Menu.” “Attach to Users” is selected in order to attach a defined role to a user, and takes the security administrator to the screen shown in FIG. 13, previously discussed above. “Attach to Privileges” is selected in order to attach a defined role to a privilege, and takes the security administrator to a screen called “Attach Application Roles to Privileges,” discussed below.

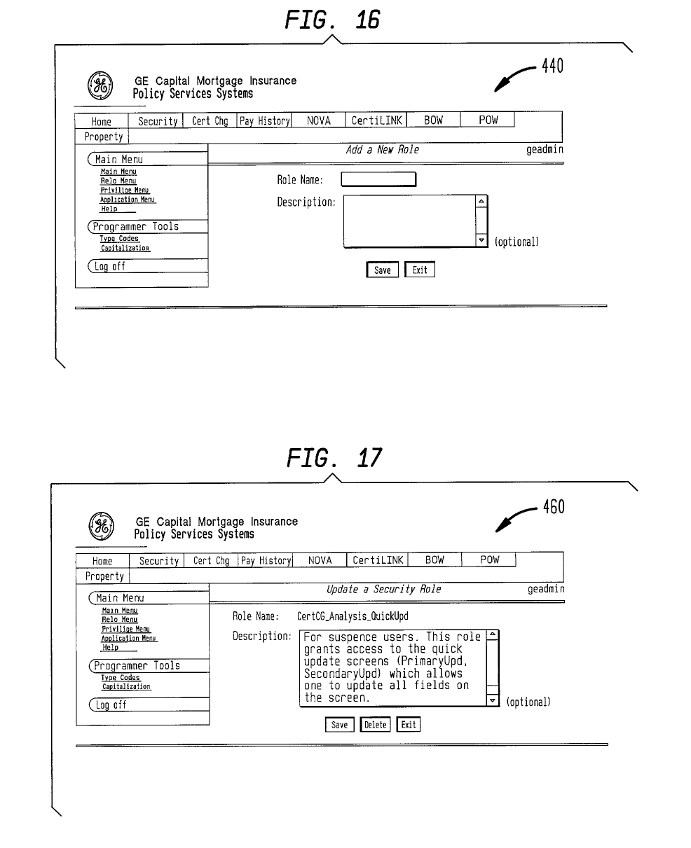

FIGS. 16 and 17 show “Add a New Role” and “Update a Security Role” screens 440 and 460, respectively. These screens are used to define new roles and to update or modify existing roles. As discussed above, roles are a grouping device that allow access and privileges to be granted to a defined class of users rather than to each individual user. After a role is defined, it must be attached to applications, users, and privileges. Attaching a role to a user or an application is handled, respectively, by screens under the “User Menu,” discussed above, and the “Application Menu,” discussed below.

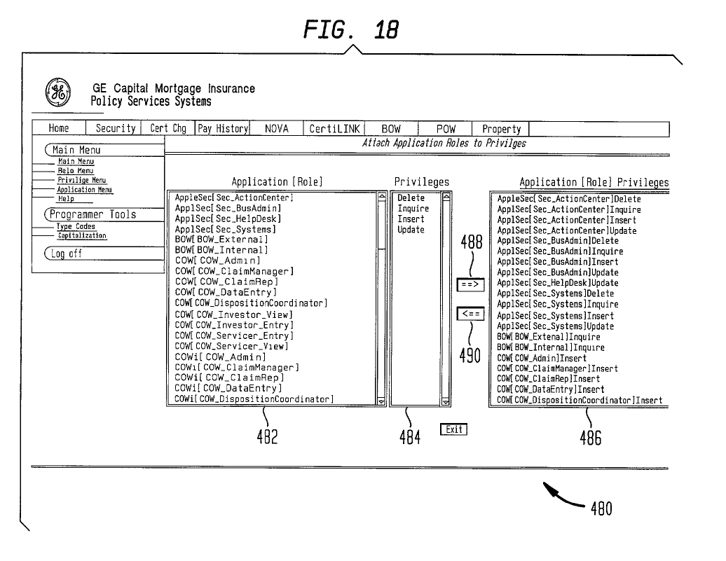

FIG. 18 shows a screenshot of an “Attach Application Roles to Privileges” screen 480. As discussed above, in addition to limiting a user's ability to access a given application, screen, or field, a further aspect of the security system also limits the functions that a user may perform on an accessed application, screen or field. This limitation is achieved by defining a set of “privileges,” which are functions that a user is allowed to perform. According to a presently preferred embodiment of the invention four basic privileges are provided: delete, inquire, insert, and update. It will be recognized that additional or different privileges may be defined as desired for a particular application and user environment. The “delete” privilege allows a user to delete previously stored data from a database. The “inquire” privilege allows a user to query the database. The “insert” privilege allows a user to insert additional data into the database. The “update” privilege allows a user to modify previously stored data in a database.

As shown in FIG. 18, the “Attach Application Roles to Privileges” screen 480 includes three list boxes: an application role box list 482, a privileges list box 484, and a third list box 486 containing assignments of privileges to application roles. Assignments are made by highlighting items in the first two boxes 482 and 484 and then clicking the right arrow 488. Assignments are removed by highlighting an item in the third box 486 and then clicking the left arrow 490. As a timesaving feature, more than one item in a list box can be highlighted at one time to allow multiple assignments, or removal of assignments, to be made simultaneously.

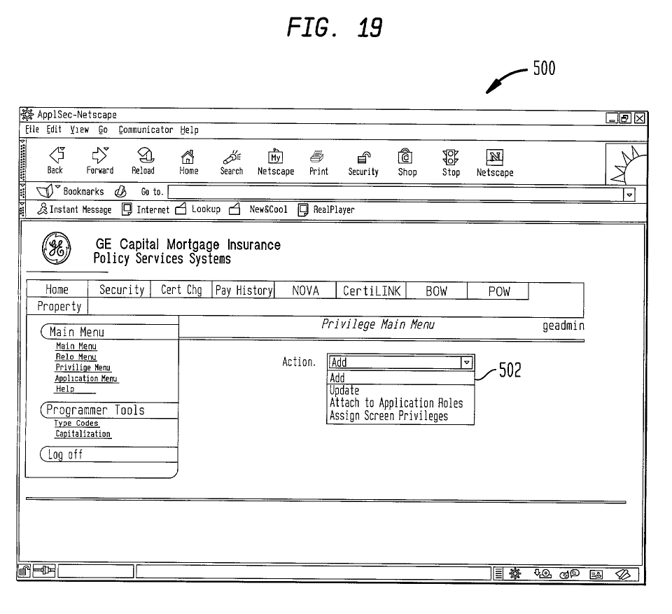

FIG. 19 shows a screenshot of the “Privilege Main Menu” screen 500, which is accessed by selecting the “Privilege Menu” option on the “Main Menu” at the left of the screen. This screen 500 includes a drop-down menu 502 listing the actions that may be performed from this screen: “Add,” “Update,” “Attach to Application Roles,” and “Assign Screen Privileges.”

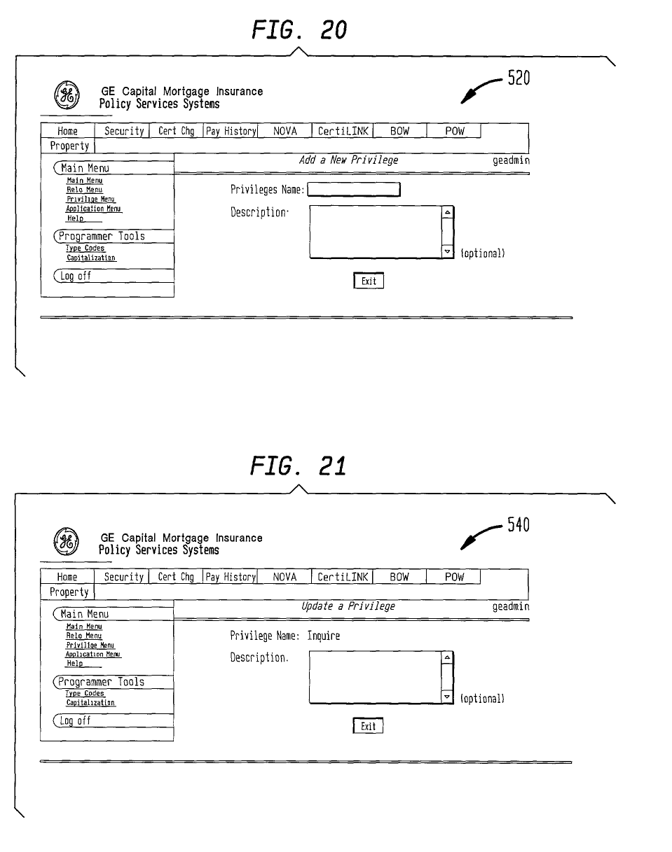

FIG. 20 shows a screenshot of an “Add a New Privilege” screen 520, which is accessed by selecting the “Add” option on the drop-down menu 502 of the “Privilege Main Menu” 500, and FIG. 21 shows a screenshot of an “Update a Privilege” screen 540, which is accessed by selecting the “Update” option on the drop-down menu 502. These screens are used, respectively, to add or update privilege information. As described above, according to an aspect of the invention four basic privileges are provided: Delete, Inquire, Insert, and Update.

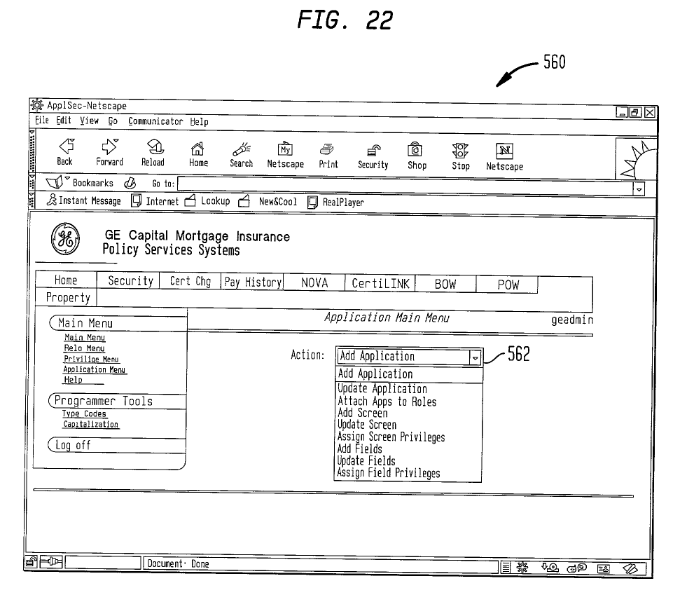

FIG. 22 shows a screenshot of an “Application Main Menu” screen 560. The screen 560 includes a drop-down menu 562 that lists the functions that can be performed from this screen. These functions include: “Add Application,” “Update Application,” “Attach Apps to Roles,” “Add Screen,” “Update Screen,” “Assign Screen Privileges,” “Add Fields,” “Update Fields,” and “Assign Field Privileges.”

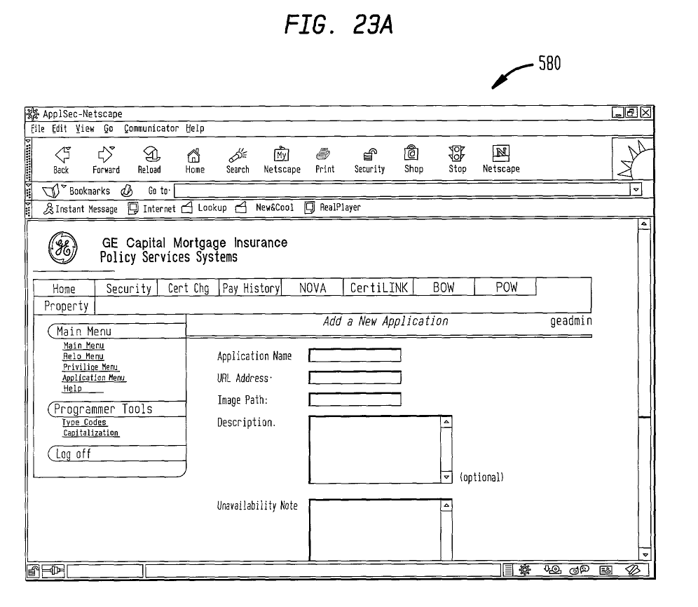

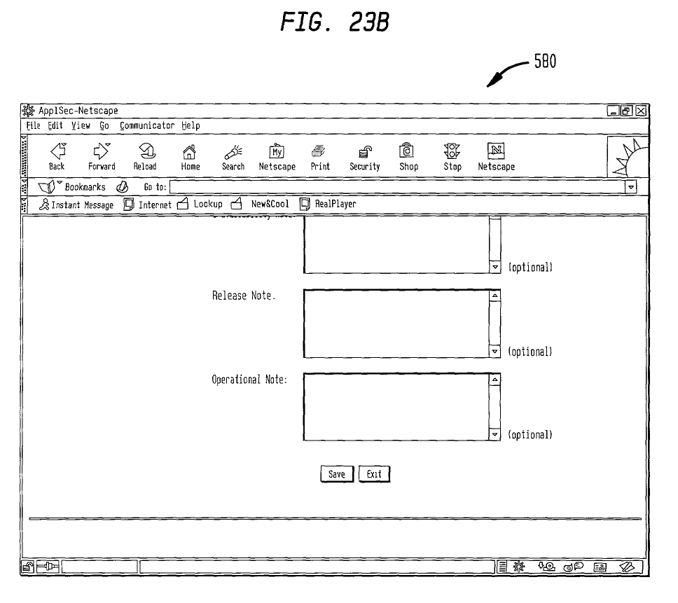

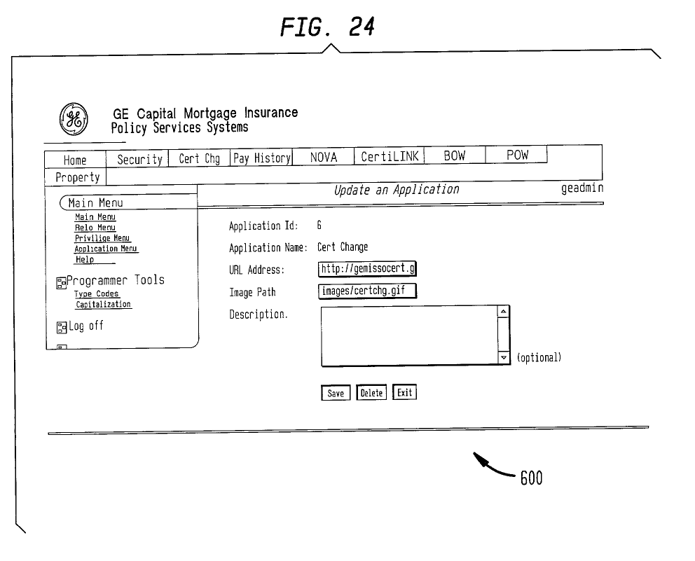

FIGS. 23A and 23B show, respectively, top and bottom halves of an “Add a New Application” screen 580, which is used to add new applications to the security system. FIG. 24 shows a screenshot of an “Update an Application” screen 600, which is used to update applications that are already in the system.

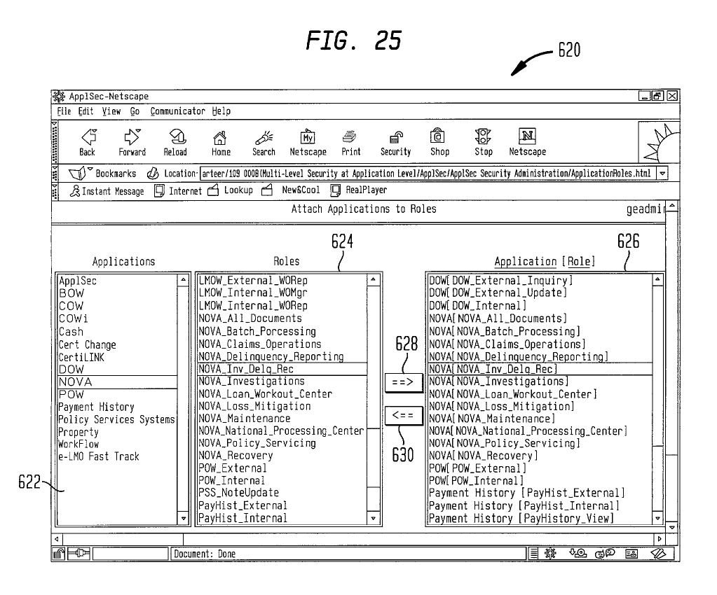

FIG. 25 shows a screenshot of an “Attach Applications to Roles” screen 620, which is used to attach applications to roles. As shown in FIG. 25, the screen 620 includes three list boxes: a first list box 622 listing applications protected by the security system, a second list box 624 listing roles, and a third list box 626 listing assignments of roles to applications. Assignments are made by highlighting entries in the first and second list boxes 622 and 624 and the clicking the right arrow 628. Assignments are removed by highlighting an entry in the third list box and then clicking the left arrow 630. As a timesaving feature, the present aspect of the invention allows more than one item in each list box to be highlighted at one time, thereby allowing multiple assignments, or removal of assignments, to be made simultaneously.

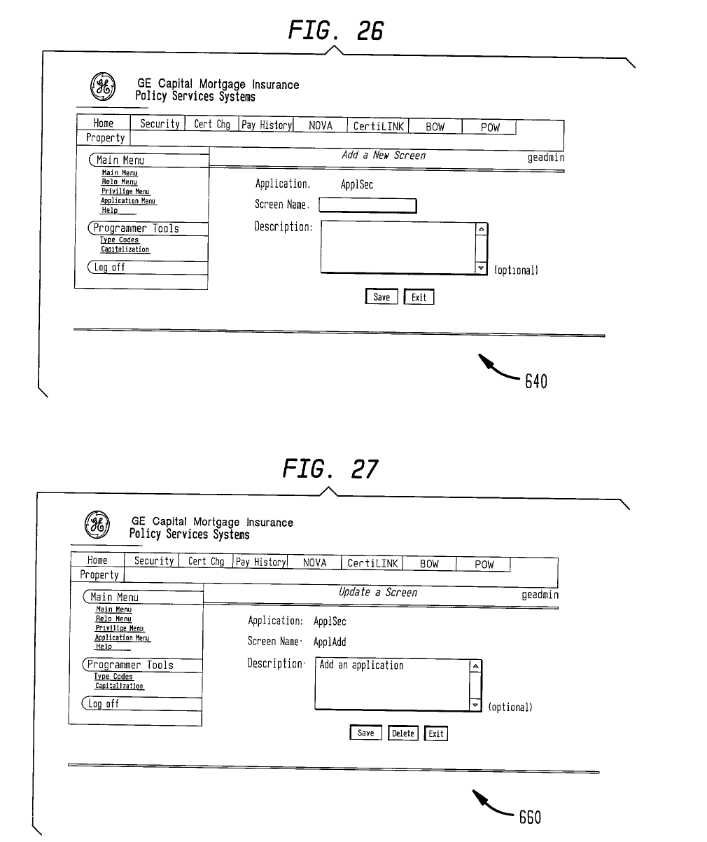

FIGS. 26 and 27 show an “Add a New Screen” screen and an “Update a Screen” screen 640 and 660, respectively. These screens are used to identify a new screen to the security system or to update information for a screen that has already been identified to the system.

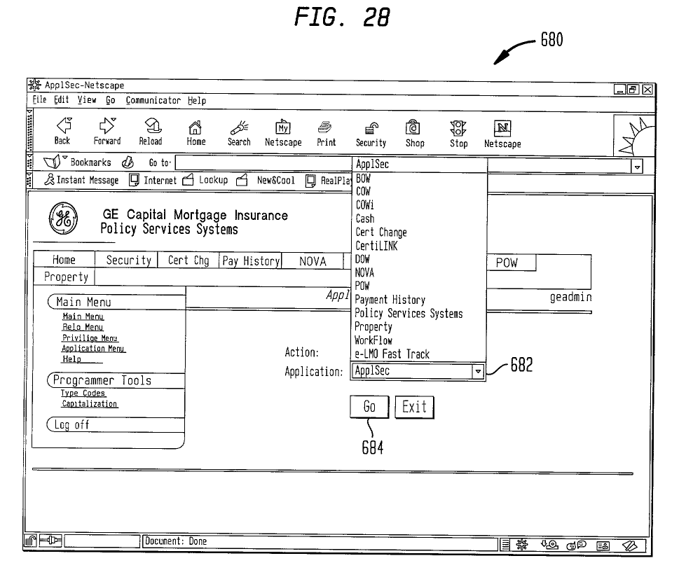

FIG. 28 shows a modified “Application Main Menu” screen 680 that appears when the security administrator selects “Assign Screen Privileges” on the Action drop-down menu 562 shown in FIG. 22, discussed above. The modified screen 680 is the same as the “Application Main Menu” screen shown in FIG. 22, with the addition of a drop-down menu 682 that lists all of the applications protected by the security system. The security administrator highlights the desired application and clicks on “Go” button 684.

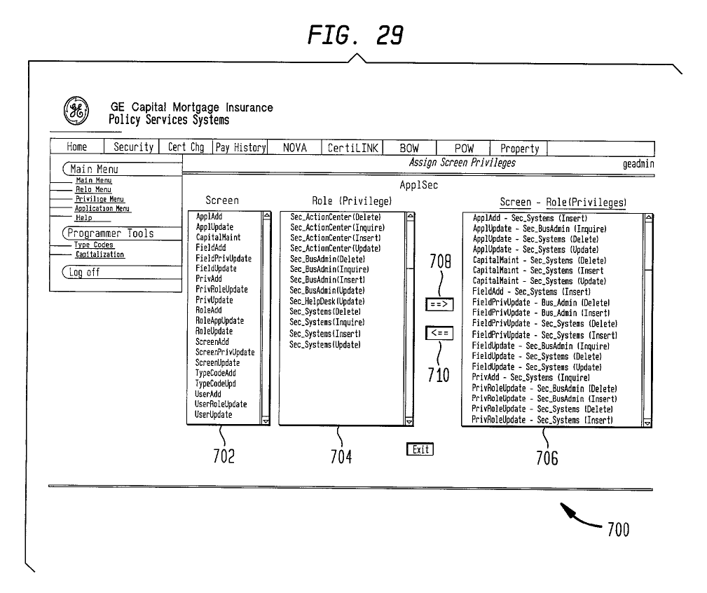

Clicking “Go” button 684 in FIG. 28 causes the screen 700 shown in FIG. 29 to appear. The screen 700 includes three list boxes 702, 704, and 706. The first list box 702 lists all the screens that have been previously defined to the selected application. The second list box 704 lists the roles that have been attached to the selected application. The attached roles include the privileges (delete, inquire, insert, update) that have been previously attached to the roles using screen 480 in FIG. 18. The third list box 706 shows the role/privilege screen assignments. Assignments are made by highlighting a screen in the first list box 702 and a role in the second list box 704 and then clicking on the right arrow 708. Assignments are removed from the third list box 706 by highlighting an assignment and then clicking on the left arrow 708. As a timesaving feature, more than one item in any of the list boxes can be highlighted at one time to allow multiple assignments or removal of assignments to be made at the same time.

FIG. 29 illustrates the flexibility of the system. A user assigned the role of Sec_Systems, attached to the application ApplSec, has been assigned privileges to several screens in the third list box 708, including ApplAdd, ApplUpdate, CapitalMaint, and FieldAdd. But for each of these screens, the Sec_Systems role has different privileges. For the ApplAdd screen, the Sec_Systems role is limited to inserting data. For the ApplUpdate screen, the Sec_Systems roles is allowed to delete, and update.

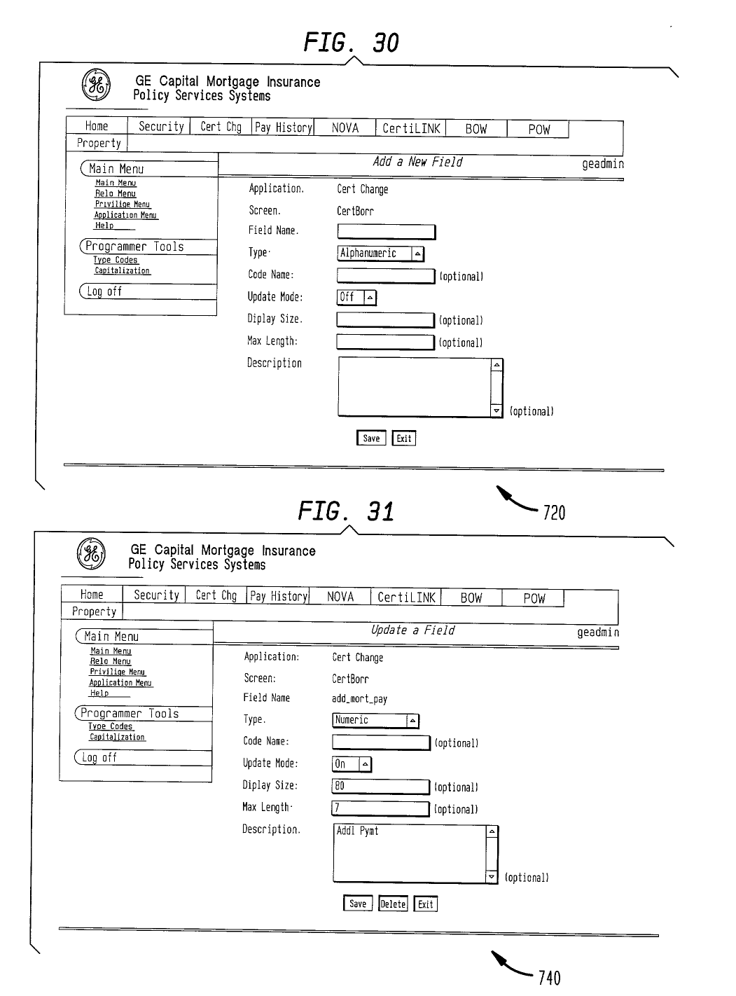

FIGS. 30 and 31 show an “Add a New Field” screen and an “Update a Field” screen 720 and 740, respectively. These screens are used to add a new field to the security system and to update information relating to a field that is already in the system.

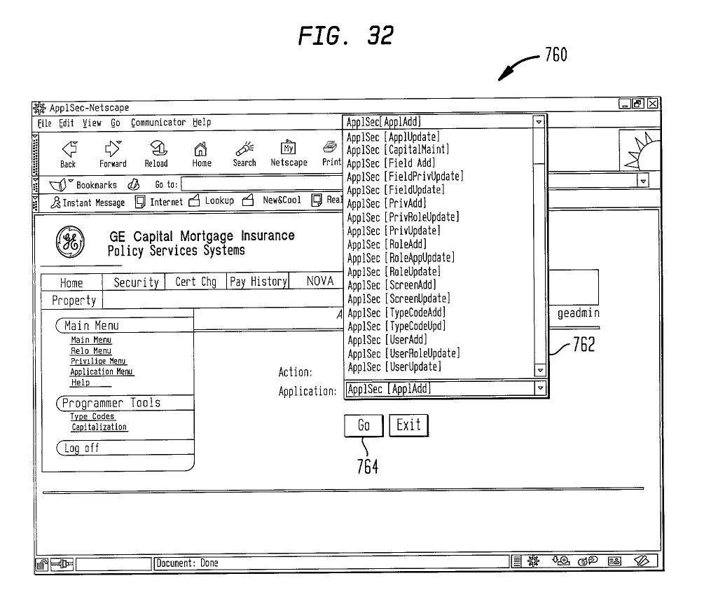

FIG. 32 shows a modified “Application Main Menu” screen 760 that appears when the security administrator clicks on the “Assign Field Privileges” option on the dropdown menu 562 of the Application Main Menu shown in FIG. 22. The modified screen 760 is the same as the Application Main Menu screen shown in FIG. 22, with the addition of a drop-down menu 764 that lists all of the application screens protected by the security system. The security administrator highlights the desired application screen and clicks on “Go” button 764.

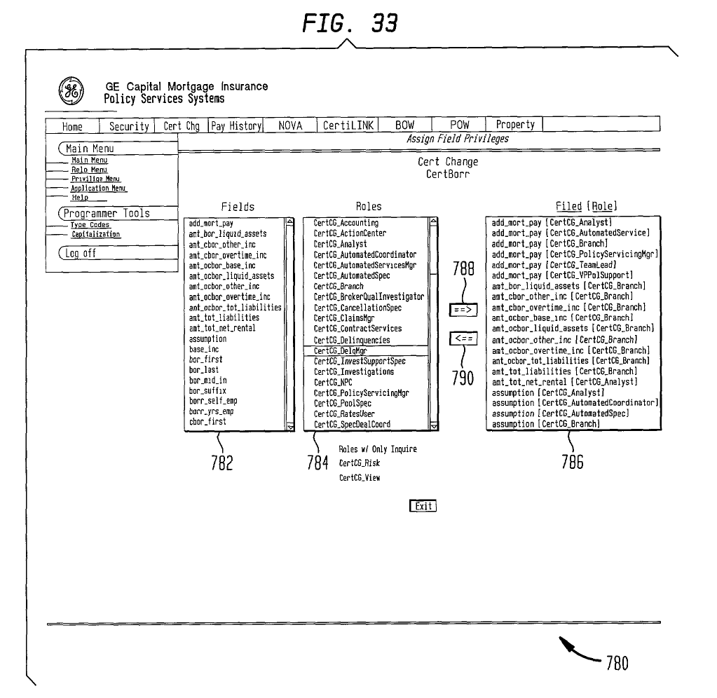

FIG. 33 shows a screen 780 that appears after “Go” button 764 is clicked in FIG. 32. The screen includes three list boxes 782, 784, and 786. The first list box 782 shows the fields that have been identified to the security system for the selected screen. The second list box 784 shows the roles that have been granted access to the screen. The third list box 786 shows the field role assignments that have been made. Assignments are made by highlighting items in the first and second list boxes 782 and 784 and clicking on the right arrow 788. Assignments are removed from the third list box 786 by clicking on the left arrow 790. The present aspect of the invention provides for timesaving by allowing more than one item in each list box to be highlighted at one time.

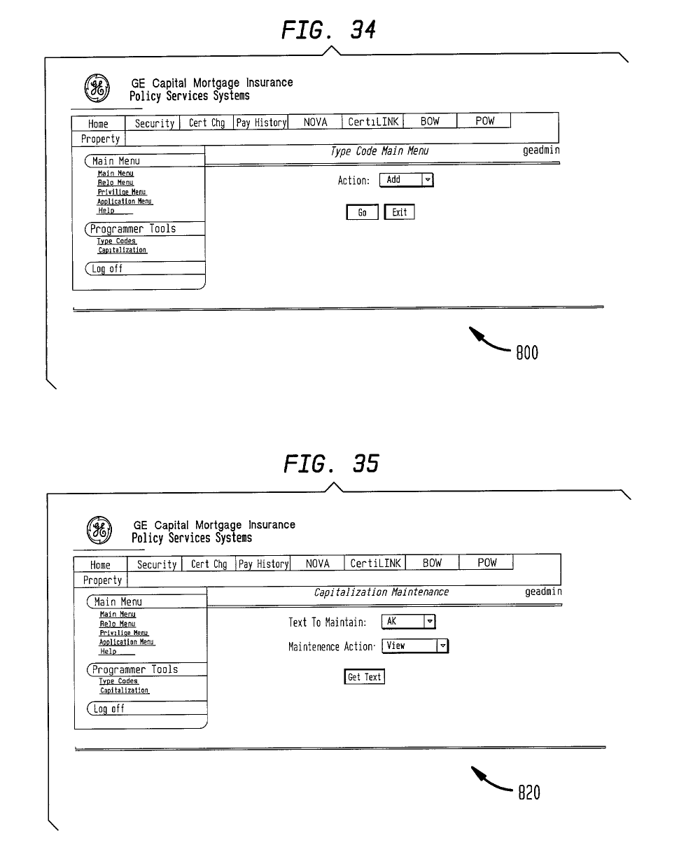

FIGS. 34 and 35 show, respectively, a “Type Code Main Menu” screen 800 and a “Capitalization Maintenance” screen 820, which are accessed through the buttons located under the heading “Programmer Tools” on the menu bar at the left of the screen. The “Type Code Main Menu” screen 800 is used to provide codes for fields. This coding is useful, for example, in the construction of list boxes. The “Capitalization Maintenance” screen 820 is used to provide the system with a list of irregularly capitalized character strings, such as abbreviations of state names, proper names, or the like. This screen and its associated functions are useful is spell checking, automatic correction, and other like functions.

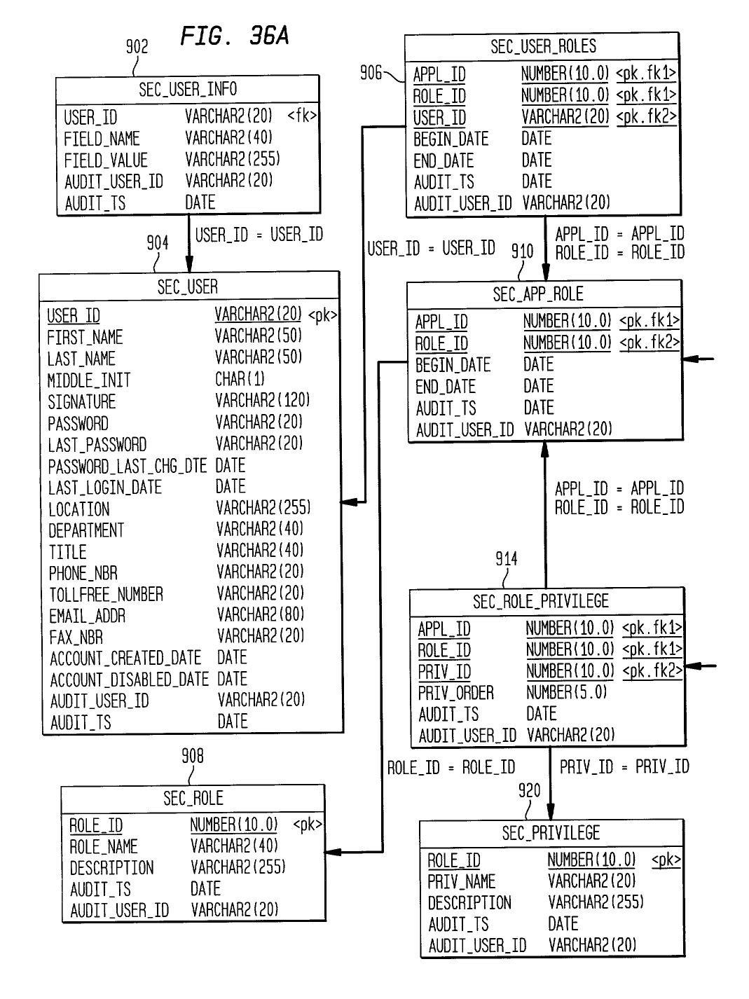

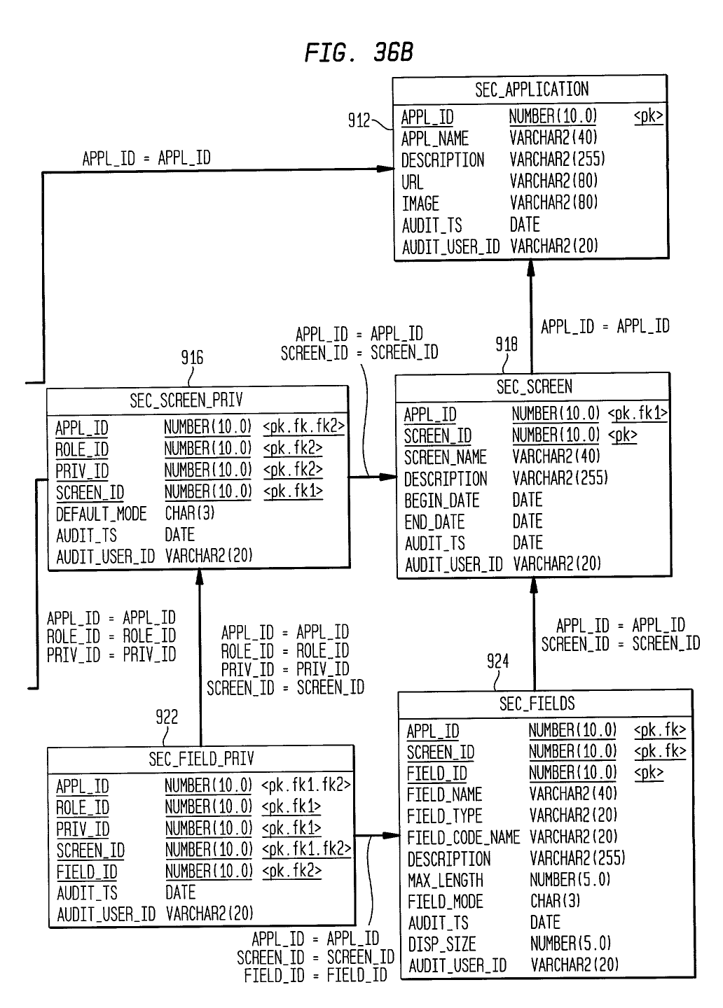

FIG. 36 shows a diagram of a configuration of data objects 900 according to a further aspect of the invention. The data objects include the following:

SEC_USER_INFO 902 is a data object that is used to store additional user data, as needed, on a per application basis.

SEC_USER 904 is a data object holding user information, including User IDs.

SEC_USER ROLES 906 is a data object holding assignments of application roles to users.

SEC_ROLE 908 is a data object holding definitions of roles.

SEC_APP_ROLE 910 is a data object holding assignments of roles to applications.

SEC_APPLICATION 912 is a data object holding definitions of applications.

SEC_ROLE_PRIVILEGE 914 is a data object holding assignments of privileges to application roles.

SEC_SCREEN_PRIV 916 is a data object holding assignments of application roles, with attached privileges, to application screens.

SEC_SCREEN 918 is a data object holding definitions of application screens.

SEC_PRIVILEGE 920 is a data object holding definitions of privileges.

SEC_FIELD_PRIV 922 is a data object holding assignments of application roles, with attached privileges, to fields on application screens.

SEC_FIELDS 924 is a data object holding definitions of fields.

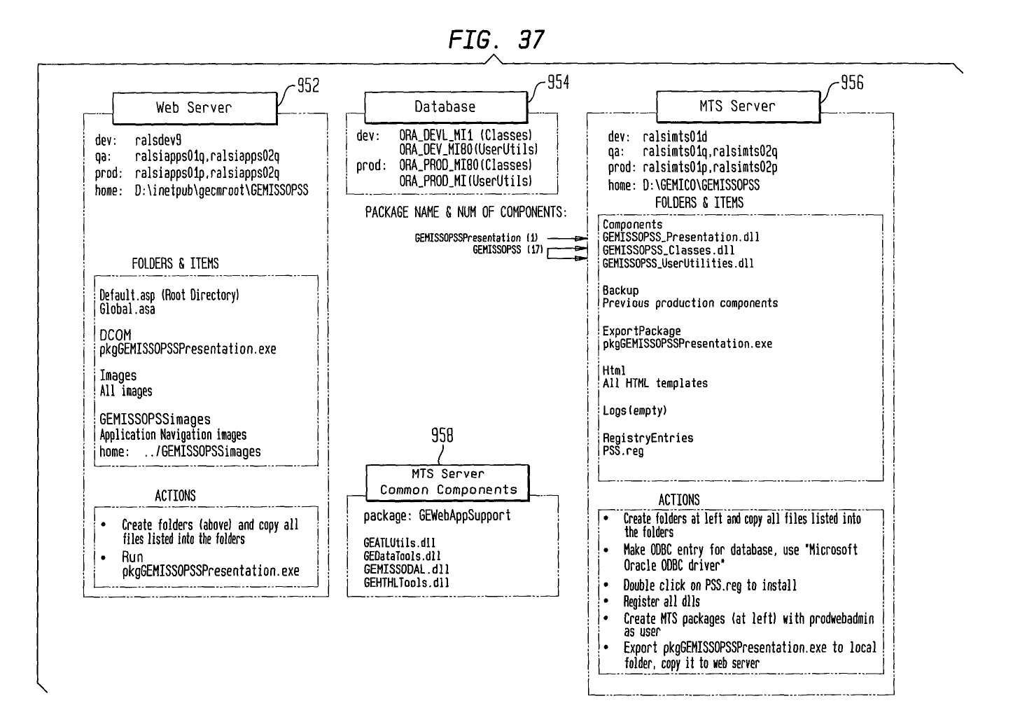

FIG. 37 is a diagram of a server setup 950 according to a further aspect of the invention. As shown in FIG. 37, the setup 950 includes a web server 952, a database 954, an MTS server 956 and MTS server common components 958. Each block lists components to be installed on each device during the process of setting up the security system. These components include folders and items, actions to be performed, and DLLs to be installed.

While the foregoing description includes details which will enable those skilled in the art to practice the invention, it should be recognized that the description is illustrative in nature and that many modifications and variations thereof will be apparent to those skilled in the art having the benefit of these teachings. It is accordingly intended that the invention herein be defined solely by the claims appended hereto and that the claims be interpreted as broadly as permitted by the prior art.

We claim:

1. A system for securing software applications, comprising:
an application programming interface for providing access to the applications; and
a database containing authorizations granting each user access to selected applications, selected application screens, and selected fields within application screens,
the application programming interface being configured such that a security software application prevents a user from gaining access to an application, screen, or field unless authorization has previously been given.

2. The system of claim 1, wherein each user is assigned a unique user identifier, each software application is assigned a unique application identifier, each screen is assigned a unique screen identifier, and each field is assigned a unique field identifier, and wherein authorizations are given to a user by attaching the user's identifier to the identifier of each authorized application, screen and field.

3. The system of claim 2, wherein the system includes a number of defined roles that are assigned unique role identifiers, and wherein authorizations are given to a user by attaching each role identifier to the respective identifiers of authorized applications, screens, and fields, and by attaching each user to a role by attaching the user's identifier to the role identifier.

4. The system of claim 3, wherein each role identifier is attached to an application identifier.

5. The system of claim 3, wherein each user is assigned privileges for each attached role, and for each authorized application, screen, and field.

6. The system of claim 5, wherein privileges are assigned to each user by assigning a unique privilege identifier to each privilege, and attaching privilege identifiers to each application, screen, and field authorization.

7. The system of claim 6, wherein the privileges include delete, inquire, insert, and update privileges.

8. The system of claim 1, wherein application fields are dynamically built into an application screen, and wherein if a user is not authorized to access a field, the field is not built into the application screen when the screen is displayed to the user.

9. The system of claim 1, wherein the applications are run in a network environment.

10. The system of claim 9, wherein the user accesses the applications using a web browser.

11. The system of claim 10, wherein active server pages are used to provide application outputs to, and receive application inputs from, the user.

12. The system of claim 10, wherein a security administrator access the security software application using a web browser.

13. A method of securing a software application, comprising the following steps:
assigning a unique user identifier to each user of the application;
assigning a unique application identifier to the application;
assigning a unique screen identifier to each application screen;
assigning a unique field identifier to each field in each application screen;
granting authorization to a user to access the application by attaching the application identifier to the user identifier;
granting authorization to a user to access an application screen by attaching the screen identifier to the user identifier;
granting authorization to a user to access a field in an application screen by attaching the field identifier to the user identifier; and
granting a request by a user to access an application, screen, or field only when it is determined that the user has been authorized to access the application, screen or field.

14. The method of claim 13, further including:
defining user roles;
assigning a unique role identifier to each role;
authorizing a user to access an application, screen, or field, by attaching each role identifier to the respective identifiers of authorized applications, screens, and fields, and by attaching each user identifier to a role identifier.

15. The method of claim 14, further including:
attaching each role identifier to an application identifier.

16. The system of claim 13, further including:
assigning privileges for each authorized application, screen, and field.

17. The method of claim 16, wherein the step of assigning privileges for each authorized application, screen, and field includes:
assigning a unique privilege identifier to each privilege, and attaching privilege identifiers to each application, screen, and field authorization.

18. The method of claim 16, wherein the step of assigning privileges for each authorized application, screen and field includes:
assigning delete, inquire, insert, and update privileges for each authorized application, screen and field.

19. The method of claim 13, further including:
dynamically building fields into application screens;
not building a field into an application screen if a user is not authorized to access the field.

20. The method of claim 1, further including:
providing network access to the application.
